(19) United States
(12) Patent Application Publication
(10) Pub. No.: US 2015/0097930 A1
(43) Pub. Date: Apr. 9, 2015

(54) STEREO CAMERA

(71) Applicant: Panasonic Intellectual Property Management Co., Ltd., Osaka (JP)

(72) Inventors: Takashi MASUNO, Osaka (JP); Tatsuro JURI, Osaka (JP); Hiroaki SHIMAZAKI, Tokyo (JP); Kenjiro TSUDA, Kyoto (JP); Yuji NAGAISHI, Osaka (JP)

(21) Appl. No.: 14/569,384

(22) Filed: Dec. 12, 2014

Related U.S. Application Data
(63) Continuation of application No. PCT/JP2014/000022, filed on Jan. 8, 2014.

(30) Foreign Application Priority Data
Jan. 25, 2013 (JP) 2013-011632

(51) Int. Cl. H04N 13/02; G03B 35/00; G03B 13/36

(52) U.S. Cl. CPC H04N 13/0296; G03B 13/36; G03B 35/00; H04N 13/0239
USPC 348/47

(57) ABSTRACT

A first camera for capturing an image of a subject, a second camera for capturing an image of a subject, an optical component disposed on an optical path when the first camera images a subject, and on an optical path when the second camera images a subject, and an adjuster for adjusting a distance between an optical axis of the first camera and an optical axis of the second camera by moving at least one of the first camera and the second camera horizontally are included. The adjuster can move at least one of the first camera and the second camera horizontally in a wider range when a zoom ratio of the first camera and the second camera is a first ratio than when the zoom ratio is a second ratio that is lower than the first ratio.

### BACKGROUND

1. Field

The present invention relates to stereo cameras.

2. Description of Related Art

Unexamined Japanese Patent Publication No. H10-133306 discloses a three-dimensional imaging device. This three-dimensional imaging device guides light beams received by two apertures in successive periods by a combination of a broad-band polarized beam splitter and an optical retarder to an image sensing device.

With this, the three-dimensional imaging device can capture three-dimensional images only by using a single lens unit and a single CCD unit.

### SUMMARY

A stereo camera in this disclosure includes a first camera for capturing an image of a subject, the first camera having a zoom function of adjusting a zoom ratio, a second camera for capturing an image of a subject, the second camera having the zoom function, an optical component disposed on an optical path when the first camera images a subject, and on an optical path when the second camera images a subject, and an adjuster for adjusting a distance between an optical axis of the first camera and an optical axis of the second camera by moving at least one of the first camera and the second camera horizontally, the adjuster being able to move at least one of the first camera and the second camera horizontally in a wider range when the zoom ratio of the first camera and the second camera is a first ratio than when the zoom ratio is a second ratio that is lower than the first ratio.

A stereo camera in this disclosure includes a first camera for capturing an image of a subject, the first camera having a zoom function of adjusting a zoom ratio, a second camera for capturing an image of a subject, the second camera having the zoom function, an adjuster for adjusting a distance between an optical axis of the first camera and an optical axis of the second camera by moving at least one of the first camera and the second camera horizontally, an optical component disposed on an optical path when the first camera images a subject, and on an optical path when the second camera images a subject, and a controller being able to change the zoom ratio of the first camera and the second camera in a wider range when the distance between the optical axis of the first camera and the optical axis of the second camera is a first distance than when the distance is a second distance that is larger than the first distance.

### BRIEF DESCRIPTION OF DRAWINGS

FIG. 1A is a schematic diagram illustrating a state in which optical axes of two cameras included in stereo camera 100 are closest to each other when a zoom ratio of the two cameras is a maximum wide angle.

FIG. 1B is a schematic diagram illustrating a state in which the optical axes of the two cameras included in stereo camera 100 are most distant from each other when the zoom ratio of the two cameras is the maximum wide angle.

FIG. 2A is a schematic diagram illustrating a state in which the optical axes of the two cameras included in stereo camera 100 are closest to each other when the zoom ratio of the two cameras is a maximum telephoto.

FIG. 2B is a schematic diagram illustrating a state in which the optical axes of the two cameras included in stereo camera 100 are most distant from each other when the zoom ratio of the two cameras is the maximum telephoto.

FIG. 3 is a block diagram illustrating an electrical configuration of stereo camera 100.

FIG. 4 is a table showing a control information table as a table.

FIG. 5 is a graph plotting the control information table on coordinates.

FIG. 6 is a flowchart illustrating an operation in a standby state.

FIG. 7 is a flowchart illustrating an operation of the stereo camera 100 when an instruction to move at least one of left-eye camera 110 and right-eye camera 120 horizontally is received from a user.

FIG. 8 is a flowchart illustrating an operation of stereo camera 100 when an instruction to change the zoom ratio of left-eye camera 110 and right-eye camera 120 is received from the user.

FIG. 9 is a schematic diagram illustrating a state in which optical axes of two cameras are most distant from each other when a convergence angle formed by the two cameras is zero.

FIG. 10 is a schematic diagram illustrating a state in which the convergence angle formed by the two cameras is greater than zero when the optical axes of the two cameras are separated by a distance equal to a maximum interocular distance shown in FIG. 9.

FIG. 11 is a schematic diagram illustrating a state in which the optical axes of the two cameras are most separated from each other when the two cameras form a convergence angle equal to that shown in FIG. 10.

FIG. 12 is a block diagram illustrating an electrical configuration of stereo camera 200.

FIG. 13 is a table showing a control information table as a table.

FIG. 14 is a graph plotting the control information table on coordinates.

### DETAILED DESCRIPTION

Hereinafter, with reference to drawings as appropriate, exemplary embodiments will be described in detail. However, details more than necessary will not be described. For example, detailed descriptions of well-known matters and redundant descriptions of substantially identical structures will not be given. This is to prevent the following description from being unnecessarily redundant, and to facilitate understanding of those skilled in the art.

The inventors provide the accompanying drawings and the following description for those skilled in the art to fully understand the present disclosure, and do not intend to limit the subject specified in the claims by them.

### First Exemplary Embodiment

A first exemplary embodiment will be described with reference to the drawings.

[1-1. Outline]

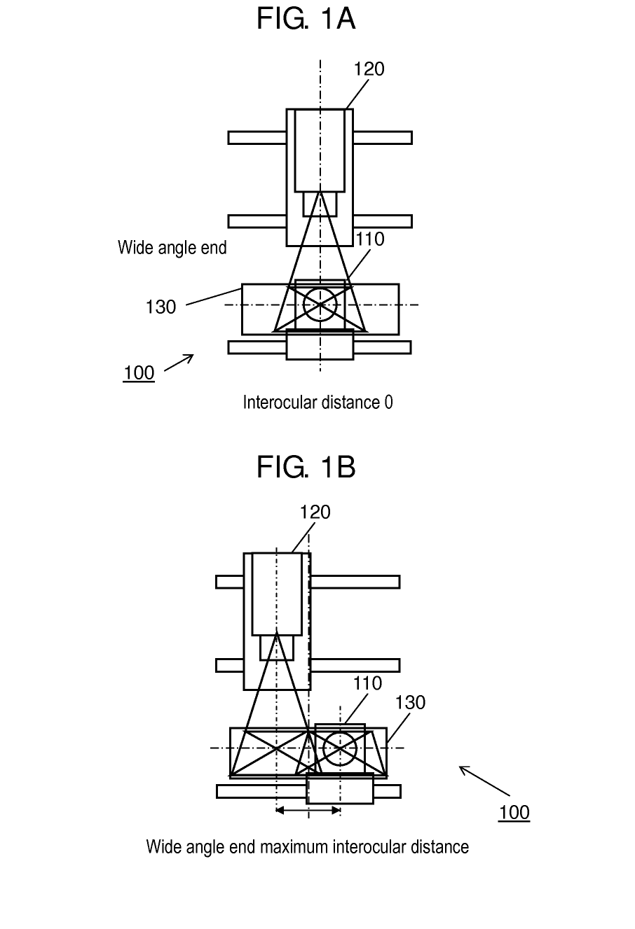

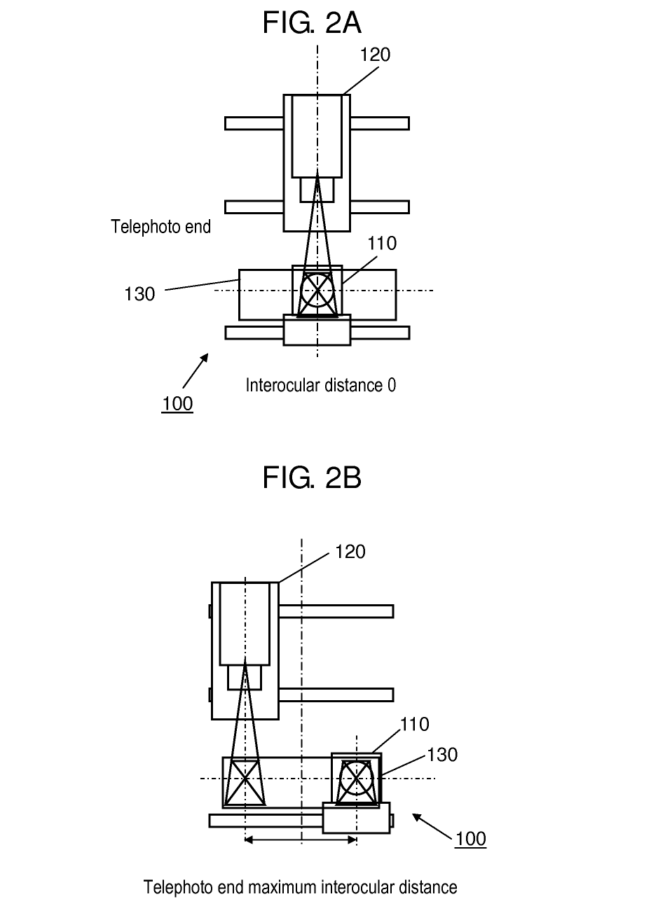

An outline of stereo camera 100 according to this exemplary embodiment will be described with reference to FIGS. 1A, 1B, 2A, and 2B. FIGS. 1A and 1B are schematic diagrams for illustrating a movable range of two cameras included in stereo camera 100 when a zoom ratio of the two cameras is a maximum wide angle. More specifically, FIG. 1A is a schematic diagram illustrating a state in which optical axes of the two cameras are closest to each other when the zoom ratio of the two cameras is the maximum wide angle. FIG. 1B is a schematic diagram illustrating a state in which the optical axes of the two cameras are most distant from each other when the zoom ratio of the two cameras is the maximum wide angle. FIGS. 2A and 2B are schematic diagrams for illustrating a movable range of the two cameras when the zoom ratio of the two cameras included in stereo camera 100 is a maximum telephoto. More specifically, FIG. 2A is a schematic diagram illustrating a state in which the optical axes of the two cameras are closest to each other when the zoom ratio of the two cameras is the maximum telephoto. FIG. 2B is a schematic diagram illustrating a state in which the optical axes of the two cameras are most distant from each other when the zoom ratio of the two cameras is the maximum telephoto.

Stereo camera 100 is a camera for capturing images for stereoscopic vision. As shown in FIGS. 1A to 2B, stereo camera 100 includes left-eye camera 110, right-eye camera 120, and beam splitter 130. Left-eye camera 110 and right-eye camera 120 are cameras for capturing images of a subject. Left-eye camera 110 captures images for a left eye for stereoscopic vision. Right-eye camera 120 captures images for a right eye for stereoscopic vision. When left-eye camera 110 captures images for a right eye, right-eye camera 120 captures images for a left eye. Left-eye camera 110 and right-eye camera 120 have a zoom function of adjusting the zoom ratio. As shown in FIGS. 1A to 2B, left-eye camera 110 faces toward a front of the figures. As shown in FIGS. 1A to 2B, right-eye camera 120 faces downward of the figures.

Beam splitter 130 is an optical member in a substantially cubic shape. Beam splitter 130 has an optical functional surface for reflecting a portion of incident light entering from an incidence plane side and letting the rest of the incident light pass therethrough to a plane opposite to the incidence plane.

Left-eye camera 110 and right-eye camera 120 are movably mounted on rails. Left-eye camera 110 and right-eye camera 120 can move horizontally on the rails. By moving at least one of left-eye camera 110 and right-eye camera 120 horizontally to increase an interocular distance that is a distance between an optical axis of left-eye camera 110 and an optical axis of right-eye camera 120, stereo camera 100 can capture an image with a sense of greater depth. A structure for moving at least one of left-eye camera 110 and right-eye camera 120 horizontally may be a structure for moving only one of left-eye camera 110 and right-eye camera 120 horizontally, or may be a structure for moving both left-eye camera 110 and right-eye camera 120 horizontally.

Left-eye camera 110 is disposed in a position in which left-eye camera 110 can image light passing through beam splitter 130. Right-eye camera 120 is disposed in a position in which right-eye camera 120 can image light reflected upward in beam splitter 130. In other words, beam splitter 130 is disposed on an optical path when left-eye camera 110 images a subject, and on an optical path when right-eye camera 120 images a subject.

Beam splitter 130 is a relatively expensive member. Thus, making beam splitter 130 as small as possible is economically desirable. However, when the size of beam splitter 130 is reduced, horizontal positions of left-eye camera 110 and right-eye camera 120 cannot be much separated from each other. In other words, the distance between the optical axis of left-eye camera 110 and the optical axis of right-eye camera 120 cannot be much increased. This is because horizontally separating left-eye camera 110 and right-eye camera 120 from each other too much without considering the size of beam splitter 130 results in a portion of light of a subject not passing through beam splitter 130. In this case, light not having passed through beam splitter 130 is not imaged by right-eye camera 120. As a result, stereo camera 100 cannot capture an image appropriate for stereoscopic vision.

Therefore, it is necessary to maintain a range in which the distance between the optical axis of left-eye camera 110 and the optical axis of right-eye camera 120 can be increased as large as possible within a range in which appropriate stereoscopic vision can be imaged while the size of beam splitter 130 is made as small as possible. This is because if the distance between the optical axis of left-eye camera 110 and the optical axis of right-eye camera 120 cannot be sufficiently increased, stereo camera 100 will have difficulty in capturing an image with a sense of depth for stereoscopic vision.

The range in which the distance between the optical axis of left-eye camera 110 and the optical axis of right-eye camera 120 can be increased depends on the zoom ratio of left-eye camera 110 and right-eye camera 120. When the zoom ratio of left-eye camera 110 and right-eye camera 120 is the maximum wide angle, a wide angle end maximum interocular distance shown in FIG. 1B is a maximum distance to which the distance between the optical axis of left-eye camera 110 and the optical axis of right-eye camera 120 can be increased. On the other hand, when the zoom ratio of left-eye camera 110 and right-eye camera 120 is the maximum telephoto, a telephoto end maximum interocular distance shown in FIG. 2B is a maximum distance to which the distance between the optical axis of left-eye camera 110 and the optical axis of right-eye camera 120 can be increased.

That is, as is clear from FIGS. 1B and 2B, the optical axis of left-eye camera 110 and the optical axis of right-eye camera 120 can be moved in a wider range when the zoom ratio of left-eye camera 110 and right-eye camera 120 is the maximum telephoto than when the zoom ratio is the maximum wide angle. Thus, the optical axis of left-eye camera 110 and the optical axis of right-eye camera 120 can be separated from each other more when the zoom ratio is set closer to the telephoto than when the zoom ratio is set closer to the wide angle.

Therefore, stereo camera 100 according to this exemplary embodiment has left-eye camera 110, right-eye camera 120, beam splitter 130, and a structure including controller 150 and interocular distance drive unit 170. Left-eye camera 110 has a zoom function of adjusting the zoom ratio, and captures an image of a subject. Right-eye camera 120 has the zoom function and captures an image of a subject. Beam splitter 130 is disposed on an optical path when left-eye camera 110 images a subject, and on an optical path when right-eye camera 120 images a subject. The structure including controller 150 and interocular distance drive unit 170 moves at least one of left-eye camera 110 and right-eye camera 120 horizontally, thereby adjusting the distance between the optical axis of left-eye camera 110 and the optical axis of right-eye camera 120. The structure including controller 150 and interocular distance drive unit 170 can move at least one of left-eye camera 110 and right-eye camera 120 horizontally in a wider range when the zoom ratio of left-eye camera 110 and right-eye camera 120 is a first ratio than when the zoom ratio is a second ratio that is lower than the first ratio.

This allows stereo camera 100 to move the distance between the optical axis of left-eye camera 110 and the optical axis of right-eye camera 120 in as wide a range as possible.

A configuration and operation of stereo camera 100 according to this exemplary embodiment will be described in detail below.

[1-2. Configuration]

[1-2-1. Electrical Configuration]

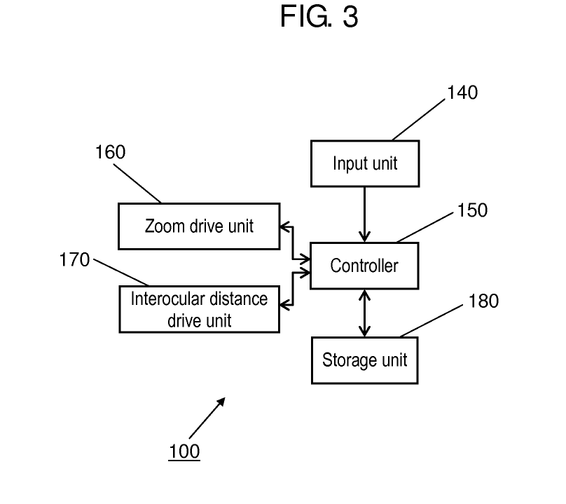

An electrical configuration of stereo camera 100 will be described with reference to FIG. 3. FIG. 3 is a block diagram illustrating the electrical configuration of stereo camera 100.

Stereo camera 100 includes input unit 140, controller 150, zoom drive unit 160, interocular distance drive unit 170, and storage unit 180. Stereo camera 100 receives, via input unit 140, from a user an instruction to change the zoom ratio and an instruction on how much to increase the distance between the optical axis of left-eye camera 110 and the optical axis of right-eye camera 120. Upon reception of an instruction via input unit 140, controller 150 controls at least one of zoom drive unit 160 and interocular distance drive unit 170 in accordance with the received instruction. Thus, according to an instruction received from the user, stereo camera 100 performs setting of the zoom ratio of left-eye camera 110 and right-eye camera 120 and/or setting of the distance between the optical axis of left-eye camera 110 and the optical axis of right-eye camera 120. Each component will be described below.

Input unit 140 is a general name for an operation interface for receiving an operation from the user. For example, input unit 140 includes a touch panel, a cross key, a zoom ring, and a zoom lever. When input unit 140 is operated, a control signal associated with content of the operation is transmitted to controller 150.

Controller 150 is a controller for controlling entire stereo camera 100. Controller 150 may include a hard-wired electronic circuit, or may include a microcomputer or the like.

Storage unit 180 is a memory for storing information. For example, storage unit 180 includes a flash memory. Storage unit 180 stores a control information table that shows a relationship between the zoom ratio of left-eye camera 110 and right-eye camera 120 and the maximum interocular distance. The control information table will be described below.

Zoom drive unit 160 adjusts the zoom ratio of left-eye camera 110 and right-eye camera 120. For example, zoom drive unit 160 includes zoom lenses included in left-eye camera 110 and right-eye camera 120 and motors for driving the zoom lenses.

Interocular distance drive unit 170 adjusts the distance between the optical axis of left-eye camera 110 and the optical axis of right-eye camera 120. For example, interocular distance drive unit 170 includes carriages on which left-eye camera 110 and right-eye camera 120 are placed. The carriages can move on rails by motors.

[1-2-2. Relationship Between Zoom Ratio and Maximum Interocular Distance]

As described above, stereo camera 100 controls the maximum interocular distance that is a maximum distance by which the distance between the optical axis of left-eye camera 110 and the optical axis of right-eye camera 120 can be increased, according to a zoom ratio of left-eye camera 110 and right-eye camera 120. Stereo camera 100 also controls the range in which the zoom ratio of left-eye camera 110 and right-eye camera 120 can be changed, according to a distance between the optical axis of left-eye camera 110 and the optical axis of right-eye camera 120.

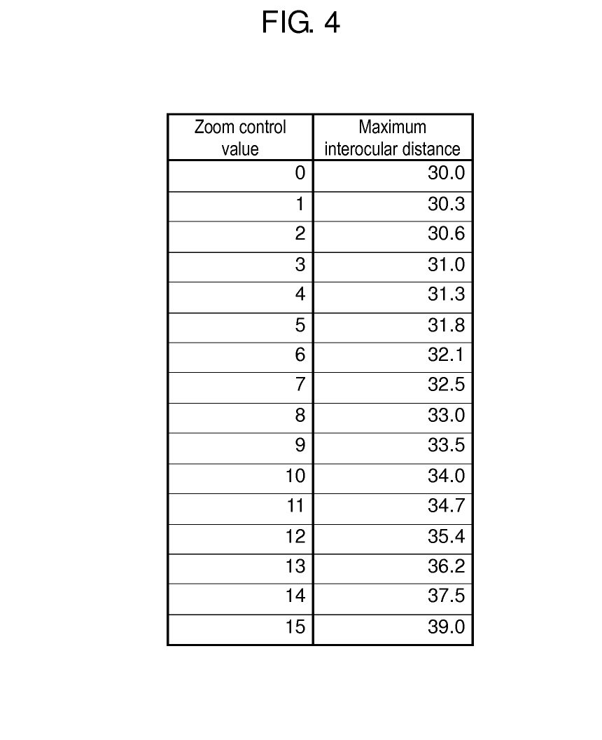

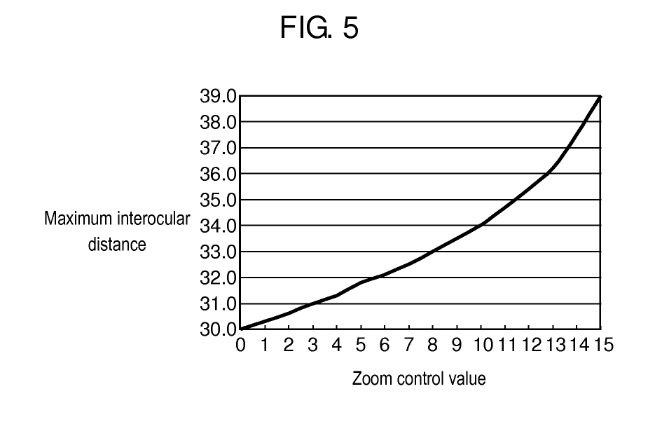

In order to implement this control, stereo camera 100 stores, in storage unit 180, the control information table that shows the relationship between the zoom ratio of left-eye camera 110 and right-eye camera 120 and the maximum interocular distance. With reference to FIGS. 4 and 5, the relationship between the zoom ratio of left-eye camera 110 and right-eye camera 120 and the maximum interocular distance will be described. FIG. 4 is a table showing the control information table as a table. FIG. 5 is a graph plotting information shown in FIG. 4 on coordinates. Data shown in FIGS. 4 and 5 is data obtained experimentally.

As shown in FIG. 4, the zoom ratio of left-eye camera 110 and right-eye camera 120 can be shifted in a range of sixteen stages. Here, a zoom control value of zero is set as the maximum wide angle, and a zoom control value of fifteen is set as the maximum telephoto. A zoom control value and a position on optical axes of zoom lenses of left-eye camera 110 and right-eye camera 120 have a one-to-one relationship.

The control information table stored in storage unit 180 includes information on the maximum interocular distance that shows to what extent the distance between the optical axis of left-eye camera 110 and the optical axis of right-eye camera 120 can be increased, for each stage of the zoom ratio. As shown in FIG. 5, as the zoom ratio gets closer to the telephoto from the wide angle, the maximum interocular distance increases. However, the relationship between the zoom ratio and the maximum interocular distance is not necessarily a proportional relationship. The relationship between the zoom ratio and the maximum interocular distance depends on optical properties of the lenses included in the two cameras of stereo camera 100. For example, depending on the optical properties of the lenses, the relationship between the zoom ratio and the maximum interocular distance may vary in a serpentine curve.

By referring to the control information table stored in storage unit 180, controller 150 determines how far the optical axis of left-eye camera 110 and the optical axis of right-eye camera 120 can be separated from each other for each zoom ratio of left-eye camera 110 and right-eye camera 120. Also, by referring to the control information table stored in storage unit 180, controller 150 determines in what range the zoom ratio of left-eye camera 110 and right-eye camera 120 can be changed in accordance with the interocular distance between the optical axis of left-eye camera 110 and the optical axis of right-eye camera 120.

[1-3. Operation]

[1-3-1. Operation in Standby State]

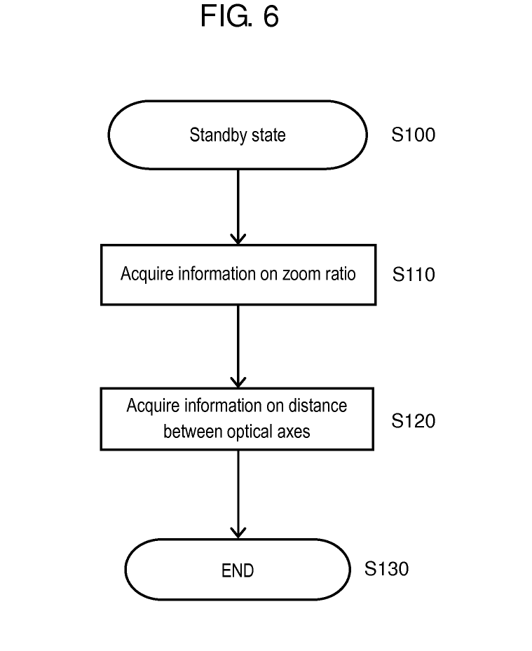

An operation in a standby state will be described with reference to FIG. 6. FIG. 6 is a flowchart showing an operation in a standby state. By turning power not shown on, stereo camera 100 shifts to a standby state (S100). The standby state is a state in which stereo camera 100 is powered and waits for an operation from a user.

In the standby state, controller 150 acquires information on a current zoom ratio from zoom drive unit 160 (S110). For example, controller 150 acquires information showing a position of the zoom lenses. By acquiring the information showing the position of the zoom lenses, controller 150 can determine the zoom ratio of left-eye camera 110 and right-eye camera 120. This is because a position of the zoom lenses and a zoom ratio has a one-to-one relationship.

Upon acquiring the information on the zoom ratio, controller 150 acquires information on the distance between the optical axis of left-eye camera 110 and the optical axis of right-eye camera 120 (S120). For example, controller 150 acquires information showing a position of the carriage on which left-eye camera 110 is placed and information showing a position of the carriage on which right-eye camera 120 is placed. This is because from the information on the positions of the two carriages, a distance between the optical axis of left-eye camera 110 and the optical axis of right-eye camera 120 can be uniquely determined.

Upon execution of processing in step S120, a process of the flowchart shown in FIG. 6 is stopped.

[1-3-2. Operation when Instruction to Move Camera(s) is Received]

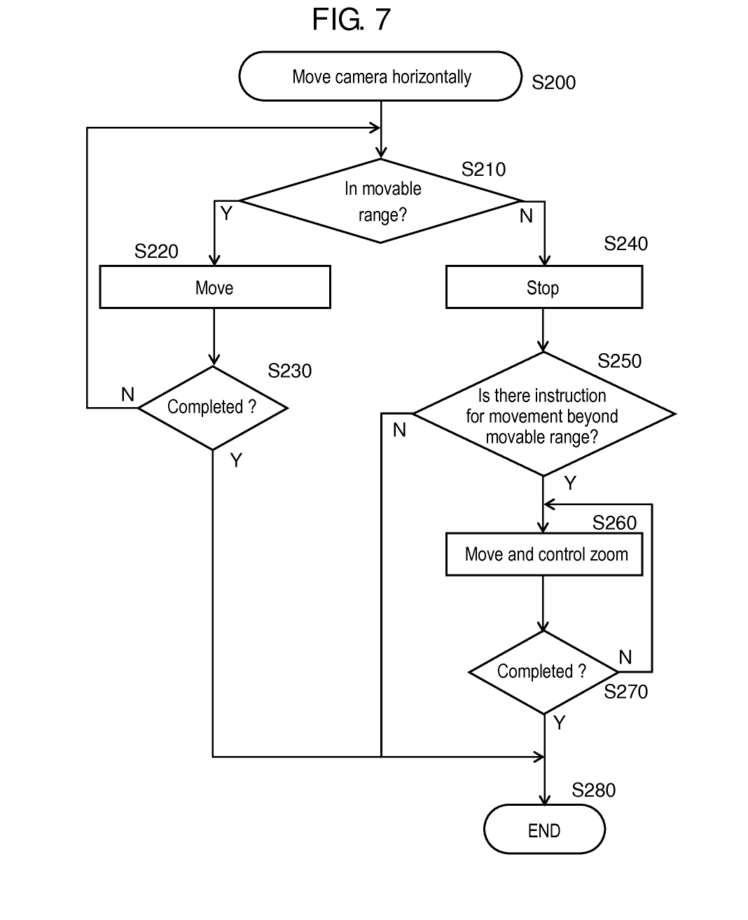

An operation of stereo camera 100 when an instruction to move at least one of left-eye camera 110 and right-eye camera 120 horizontally is received from the user will be described with reference to FIG. 7. FIG. 7 is a flowchart showing an operation of stereo camera 100 when an instruction to move at least one of left-eye camera 110 and right-eye camera 120 horizontally is received from the user.

Via input unit 140, controller 150 is caused by the user to move at least one of left-eye camera 110 and right-eye camera 120 horizontally on the rails (S200). When receiving an instruction for horizontal movement from the user, controller 150 determines whether a target value of the distance after movement is within a movable range or not (S 210). Specifically, by referring to related information stored in storage unit 180 and the information on the current zoom ratio of left-eye camera 110 and right-eye camera 120 acquired in the standby state, controller 150 determines whether the target value of the distance after movement is within the movable range or not. For example, when the zoom ratio of left-eye camera 110 and right-eye camera 120 is set to the maximum wide angle as shown in FIG. 4, controller 150 determines whether or not the target value of the distance after movement is within a range not exceeding a maximum interocular distance of 30.0. When the zoom ratio of left-eye camera 110 and right-eye camera 120 is set to the maximum telephoto, controller 150 determines whether or not the target value of the distance after movement is within a range not exceeding a maximum interocular distance of 39.0. Thus, controller 150 changes the distance by which the optical axis of left-eye camera 110 and the optical axis of right-eye camera 120 can be separated from each other, according to the zoom ratio of left-eye camera 110 and right-eye camera 120.

When controller 150 determines that the target value is within the movable range, controller 150 controls interocular distance drive unit 170 to move left-eye camera 110 and right-eye camera 120 (S 220). Upon moving left-eye camera 110 and right-eye camera 120, controller 150 determines whether the movement instruction from the user has been completed or not (S230).

When controller 150 determines that the movement instruction has been completed, controller 150 completes a process of the flowchart shown in FIG. 7 (S280). On the other hand, when controller 150 determines that the movement instruction has not been completed, controller 150 returns to step S210 to continue the process.

When controller 150 determines that the target value is not within the movable range in step S210, where at least one of left-eye camera 110 and right-eye camera 120 is being moved, controller 150 controls interocular distance drive unit 170 to stop the movement. When at least one of left-eye camera 110 and right-eye camera 120 is not being moved, controller 150 does not allow movement of both cameras to be started (S240).

Upon stopping the movement, controller 150 determines whether or not there is an instruction from the user for movement beyond the movable range (S250) also after the stopping of the movement. When controller 150 determines that there is no instruction for movement beyond the movable range, controller 150 completes the process of the flowchart shown in FIG. 7 (S280).

On the other hand, when controller 150 determines that there is an instruction for movement beyond the movable range, controller 150 controls interocular distance drive unit 170 to resume horizontal movement of at least one of left-eye camera 110 and right-eye camera 120, referring to the related information stored in storage unit 180 (S260). In parallel with the control of interocular distance drive unit 170, controller 150 also controls zoom drive unit 160 to implement change of the zoom ratio of left-eye camera 110 and right-eye camera 120 (S260). Specifically, by referring to the related information, controller 150 controls interocular distance drive unit 170 while controlling zoom drive unit 160 to change the zoom ratio of left-eye camera 110 and right-eye camera 120 such that the distance between the optical axis of left-eye camera 110 and the optical axis of right-eye camera 120 after moving at least one of left-eye camera 110 and right-eye camera 120 according to the movement instruction is include in the movable range.

Upon implementing the parallel control of interocular distance drive unit 170 and zoom drive unit 160, controller 150 determines whether the movement instruction from the user has been completed or not (S270). When the controller 150 determines that the movement instruction has not been completed, controller 150 repeats the control of interocular distance drive unit 170 and zoom drive unit 160. On the other hand, when controller 150 determines that the movement instruction has been completed, controller 150 completes the process of the flowchart shown in FIG. 7 (S280).

[1-3-3. Operation when Instruction on Zoom Control of Cameras is Received]

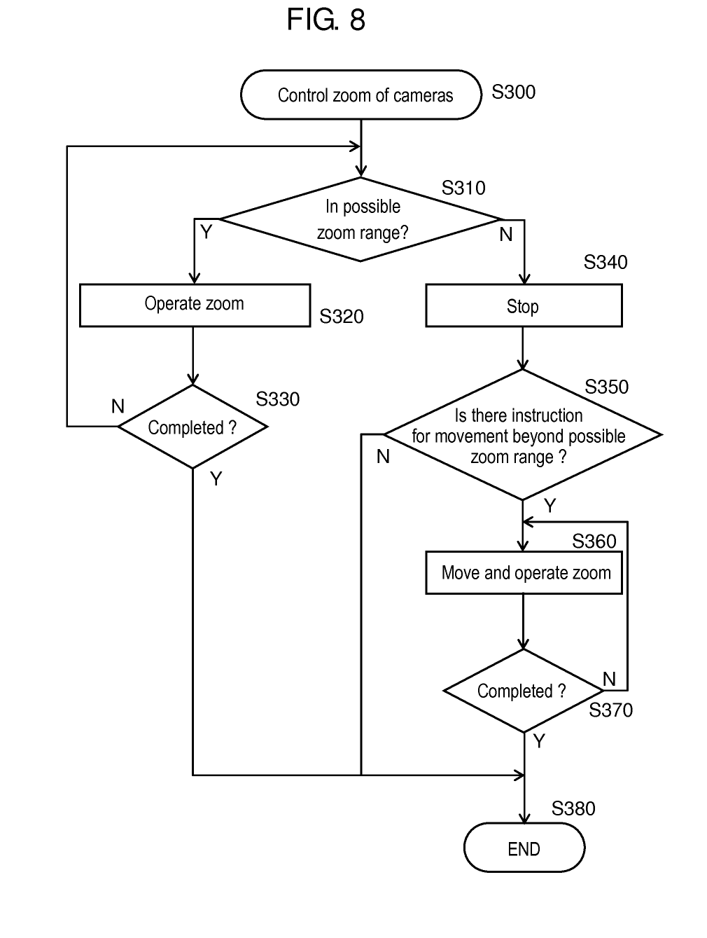

Next, an operation when an instruction to change the zoom ratio of left-eye camera 110 and right-eye camera 120 is received from the user will be described with reference to FIG. 8. FIG. 8 is a flowchart showing an operation of stereo camera 100 when an instruction to change the zoom ratio of left-eye camera 110 and right-eye camera 120 is received from a user.

Controller 150 is caused, via input unit 140, by a user to change the zoom ratio of left-eye camera 110 and right-eye camera 120 (S300). Upon receiving an instruction to change the zoom ratio from the user, controller 150 determines whether or not a target value of the zoom ratio after change is within a range in which the zoom ratio can be changed (S310). Specifically, by referring to related information stored in storage unit 180 and information on the distance between the optical axis of left-eye camera 110 and the optical axis of right-eye camera 120 acquired in the standby state, controller 150 determines whether or not the target value of the zoom ratio after change is within the range in which the zoom ratio can be changed. For example, when the distance between the optical axis of left-eye camera 110 and the optical axis of right-eye camera 120 is set at 30.0, controller 150 can change the zoom ratio of left-eye camera 110 and right-eye camera 120 from the maximum telephoto to the maximum wide angle. On the other hand, when the distance between the optical axis of left-eye camera 110 and the optical axis of right-eye camera 120 is set at 39.0, controller 150 can only set the zoom ratio of left-eye camera 110 and right-eye camera 120 at the maximum telephoto. Thus, depending on how the distance between the optical axis of left-eye camera 110 and the optical axis of right-eye camera 120 is set, controller 150 changes the range in which the zoom ratio of left-eye camera 110 and right-eye camera 120 can be changed.

When controller determines that the target value is within the range in which the zoom ratio can be changed, controller 150 controls zoom drive unit 160 to change the zoom ratio of left-eye camera 110 and right-eye camera 120 (S320). Upon changing the zoom ratio of left-eye camera 110 and right-eye camera 120, controller 150 determines whether the instruction from the user to change the zoom ratio has been completed or not (S330).

When controller 150 determines that the change instruction has been completed, controller 150 completes a process of the flowchart shown in FIG. 8 (S380). On the other hand, when controller 150 determines that the change instruction has not been completed, controller 150 returns to step S310 to continue the process.

When controller 150 determines that the target value is not within the range in which the zoom ratio can be changed in step S310, where change of the zoom ratio of left-eye camera 110 and right-eye camera 120 is being implemented, controller 150 controls zoom drive unit 160 to stop the change. When the change is not being implemented, controller 150 does not allow the change to be started (S340).

Upon stopping the change of the zoom ratio, controller 150 determines whether or not there is an instruction from the user to change the zoom ratio beyond the range in which the zoom ratio can be changed also after the stopping of the change (S350). When controller 150 determines that there is no instruction to change the zoom ratio beyond the range in which the zoom ratio can be changed, controller 150 completes the process of the flowchart shown in FIG. 8 (S380).

On the other hand, when controller 150 determines that there is an instruction to change the zoom ratio beyond the range in which the zoom ratio can be changed, controller 150 controls zoom drive unit 160 to resume the change of the zoom ratio of left-eye camera 110 and right-eye camera 120, referring to the related information stored in storage unit 180 (S360). In parallel with the control of zoom drive unit 160, controller 150 also controls interocular distance drive unit 170 to implement horizontal movement of at least one of left-eye camera 110 and right-eye camera 120 (S360). Specifically, by referring to the related information, controller 150 controls zoom drive unit 160 while controlling interocular distance drive unit 170 to adjust the distance between the optical axis of left-eye camera 110 and the optical axis of right-eye camera 120 such that the target value of the zoom ratio after change is included in the range in which the zoom ratio can be changed.

Upon implementation of the parallel control of zoom drive unit 160 and interocular distance drive unit 170, controller 150 determines whether the instruction from the user to change the zoom ratio has been completed or not (S370). When controller 150 determines that the instruction to change the zoom ratio has not been completed, controller 150 repeats the control of zoom drive unit 160 and interocular distance drive unit 170. On the other hand, when controller 150 determines that the instruction to change the zoom ratio has been completed, controller 150 completes the process of the flowchart shown in FIG. 8 (S380).

[1-4. Effects and Others]

Thus, stereo camera 100 according to this exemplary embodiment includes left-eye camera 110, right-eye camera 120, beam splitter 130, and a structure including controller 150 and interocular distance drive unit 170. Left-eye camera 110 has the zoom function of adjusting the zoom ratio, and captures an image of a subject. Right-eye camera 120 has the zoom function and captures an image of a subject. Beam splitter 130 is disposed on an optical path when left-eye camera 110 images a subject, and on an optical path when right-eye camera 120 images a subject. The structure including controller 150 and interocular distance drive unit 170 moves at least one of left-eye camera 110 and right-eye camera 120 horizontally, thereby adjusting the distance between the optical axis of left-eye camera 110 and the optical axis of right-eye camera 120. Also, the structure including controller 150 and interocular distance drive unit 170 can move at least one of left-eye camera 110 and right-eye camera 120 horizontally in a wider range when the zoom ratio of left-eye camera 110 and right-eye camera 120 is a first ratio than when the zoom ratio is a second ratio that is lower than the first ratio.

This allows stereo camera 100 to move the distance between the optical axis of left-eye camera 110 and the optical axis of right-eye camera 120 in as wide a range as possible within a range in which images appropriate for stereoscopic vision can be captured. In other words, the optical paths of left-eye camera 110 and right-eye camera 120 continuously pass through beam splitter 130. As a result, stereo camera 100 can capture an image with a less feeling of strangeness for stereoscopic vision. Further, an adjustable range of the interocular distance when the zoom ratio is set closer to the telephoto can be increased, as compared with a case where the optical axes of the two cameras when the zoom ratio of left-eye camera 110 and right-eye camera 120 is set to the maximum telephoto can be separated only to a maximum interocular distance equal to that when the zoom ratio is set to the maximum wide angle.

Stereo camera 100 according to this exemplary embodiment further includes input unit 140 and zoom drive unit 160. Input unit 140 receives an instruction from the user on the distance between the optical axis of left-eye camera 110 and the optical axis of right-eye camera 120. When the structure including controller 150 and interocular distance drive unit 170 receives an instruction from the user to move at least one of left-eye camera 110 and right-eye camera 120 horizontally beyond a range in which at least one of left-eye camera 110 and right-eye camera 120 can be moved horizontally, the structure including controller 150 and zoom drive unit 160 controls left-eye camera 110 and right-eye camera 120 to increase the zoom ratio of left-eye camera 110 and right-eye camera 120.

Thus, upon receiving an instruction from the user to increase the distance between the optical axis of left-eye camera 110 and the optical axis of right-eye camera 120 beyond a maximum range in which the distance can be increased, stereo camera 100 adjusts the zoom ratio of left-eye camera 110 and right-eye camera 120. As a result, stereo camera 100 can further increase the distance between the optical axis of left-eye camera 110 and the optical axis of right-eye camera 120 while continuing capturing images appropriate for stereoscopic vision, thus being able to capture images with a sense of depth.

Further, stereo camera 100 according to this exemplary embodiment includes left-eye camera 110, right-eye camera 120, a structure including controller 150 and interocular distance drive unit 170, beam splitter 130, and a structure including controller 150 and zoom drive unit 160. Left-eye camera 110 has the zoom function of adjusting the zoom ratio, and captures an image of a subject. Right-eye camera 120 has the zoom function and captures an image of a subject. The structure including controller 150 and interocular distance drive unit 170 moves at least one of left-eye camera 110 and right-eye camera 120 horizontally, thereby adjusting the distance between the optical axis of left-eye camera 110 and the optical axis of right-eye camera 120. Beam splitter 130 is disposed on an optical path when left-eye camera 110 captures an image of a subject and on an optical path when right-eye camera 120 captures an image of a subject. The structure including controller 150 and zoom drive unit 160 can change the zoom ratio of left-eye camera 110 and right-eye camera 120 in a wider range when the distance between the optical axis of left-eye camera 110 and the optical axis of right-eye camera 120 is a first distance than when the distance is a second distance that is larger than the first distance.

This allows stereo camera 100 to change the zoom ratio of left-eye camera 110 and right-eye camera 120 in as wide a range as possible within a range in which images appropriate for stereoscopic vision can be captured.

Stereo camera 100 according to this exemplary embodiment further includes input unit 140. Input unit 140 receives an instruction from the user on the zoom ratio of left-eye camera 110 and right-eye camera 120. When the structure including controller 150 and interocular distance drive unit 170 receives an instruction to change the zoom ratio of left-eye camera 110 and right-eye camera 120 to a wider angle beyond a range in which the zoom ratio of left-eye camera 110 and right-eye camera 120 can be changed, the structure including controller 150 and interocular distance drive unit 170 moves at least one of left-eye camera 110 and right-eye camera 120 horizontally to shorten the distance between the optical axis of left-eye camera 110 and the optical axis of right-eye camera 120.

Thus, upon receiving an instruction from the user to set the zoom ratio of left-eye camera 110 and right-eye camera 120 to a wider angle beyond a maximum range in which the zoom ratio can be set to a wider angle, stereo camera 100 adjusts the distance between the optical axis of left-eye camera 110 and the optical axis of right-eye camera 120. As a result, stereo camera 100 can set the zoom ratio of left-eye camera 110 and right-eye camera 120 to an even wider angle while continuing capturing images for stereoscopic vision.

### Second Exemplary Embodiment

A second exemplary embodiment will be described with reference to the drawings.

[2-1. Outline]

Stereo camera 200 according to this exemplary embodiment is different from stereo camera 100 in the first exemplary embodiment in that a convergence angle formed by two cameras can be adjusted. Therefore, stereo camera 200 according to this exemplary embodiment considers the convergence angle formed by the two cameras when setting a maximum interocular distance. This exemplary embodiment will be described mainly on differences from the first exemplary embodiment. Components identical to those in the first exemplary embodiment are denoted by identical reference numerals.

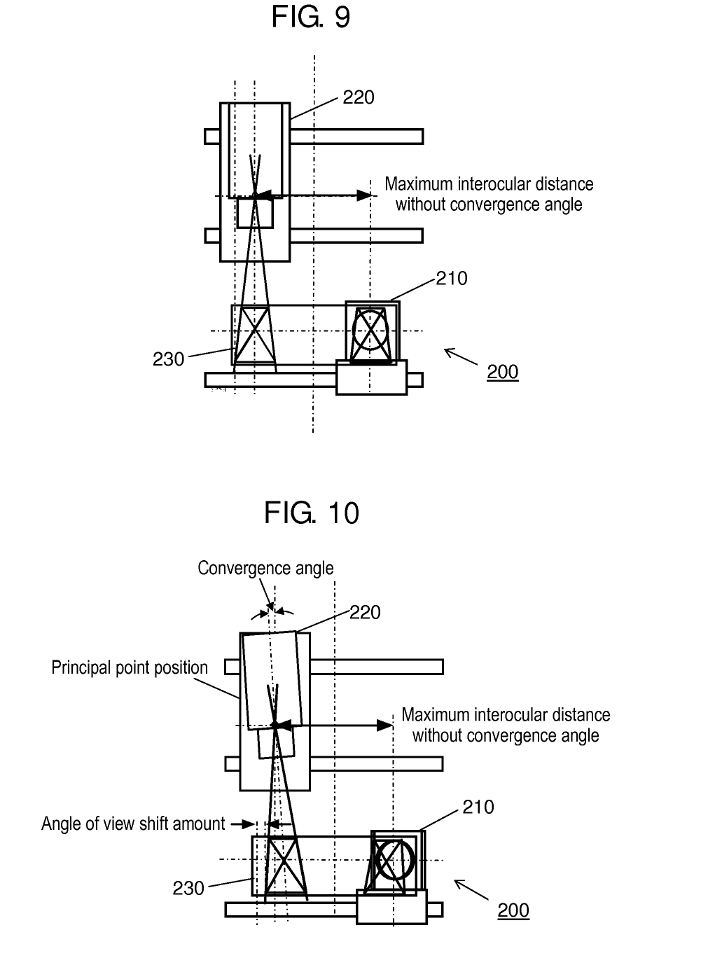

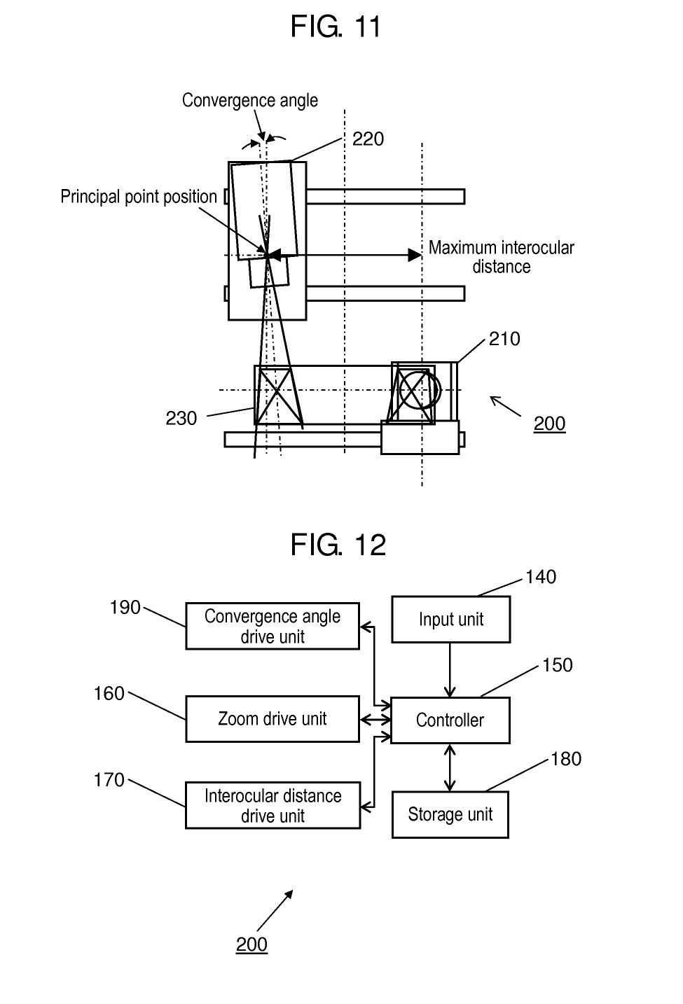

An outline of this exemplary embodiment will be described with reference to FIGS. 9 to 11. FIG. 9 is a schematic diagram illustrating a state in which optical axes of the two cameras are most distant from each other when the convergence angle formed by the two cameras is zero. FIG. 10 is a schematic diagram illustrating a state in which the convergence angle formed by the two cameras is greater than zero when the optical axes of the two cameras is separated by a distance equal to a maximum interocular distance shown in FIG. 9. FIG. 11 is a schematic diagram illustrating a state in which the optical axes of the two cameras are most separated from each other when the two cameras form a convergence angle equal to that shown in FIG. 10.

Comparison between the case shown in FIG. 9 and the case shown in FIG. 10 shows that when the convergence angle formed by the two cameras as shown in FIG. 10 becomes greater than zero, an allowance is produced on beam splitter 230 by a displacement of an angle of view. Therefore, as shown in FIG. 11, left-eye camera 210 and right-eye camera 220 can be further separated horizontally from each other than the case shown in FIG. 10. Even when the optical axis of the left-eye camera 210 and the optical axis of right-eye camera 220 are separated from each other to the state shown in FIG. 11, beams of light imaged by left-eye camera 210 and right-eye camera 220 both pass through beam splitter 230. That is, the optical axes of the two cameras can be separated further when the convergence angle formed by the two cameras is greater than zero than when the convergence angle formed by the two cameras is zero.

Thus, stereo camera 200 according to this exemplary embodiment has a structure including controller 150 and interocular distance drive unit 170. The structure including controller 150 and interocular distance drive unit 170 can adjust the convergence angle formed by left-eye camera 210 and right-eye camera 220. When the zoom ratio of left-eye camera 210 and right-eye camera 220 is the same, the structure including controller 150 and interocular distance drive unit 170 can move at least one of left-eye camera 210 and right-eye camera 220 horizontally in a wider range when the convergence angle is a first angle than when the convergence angle is a second angle that is a smaller than the first angle.

This allows stereo camera 200 to move the distance between the optical axis of left-eye camera 210 and the optical axis of right-eye camera 220 in as wide a range as possible, considering also the convergence angle formed by the two cameras.

[2-2. Configuration]

[2-2-1. Electrical Configuration]

An electrical configuration of stereo camera 200 will be described with reference to FIG. 12. A difference between stereo camera 200 and stereo camera 100 in the first exemplary embodiment is that stereo camera 200 includes convergence angle drive unit 190. Stereo camera 200 can adjust the convergence angle of the two cameras by driving convergence angle drive unit 190.

Convergence angle drive unit 190 includes rotary parts provided at a carriage on which left-eye camera 210 is placed, and a carriage on which right-eye camera 220 is placed. The rotary parts rotate on the carriage on which left-eye camera 210 is placed and on the carriage on which right-eye camera 220 is placed. Specifically, convergence angle drive unit 190 includes a base rotatably provided at the carriage on which left-eye camera 210 is placed, a base rotatably provided at the carriage on which right-eye camera 220 is placed, and motors for rotating these bases.

[2-2-2. Relationships Between Zoom Ratio, Maximum Interocular Distance, and Convergence Angle]

Differences between stereo camera 200 and stereo camera 100 according to the first exemplary embodiment include a difference in a control information table stored by storage unit 180. In the first exemplary embodiment, storage unit 180 stores the control information table on the relationship between the zoom control value and the maximum interocular distance shown in FIGS. 4 and 5. However, in this exemplary embodiment, consideration is also given to the convergence angle formed by left-eye camera 210 and right-eye camera 220 when a maximum interocular distance is determined.

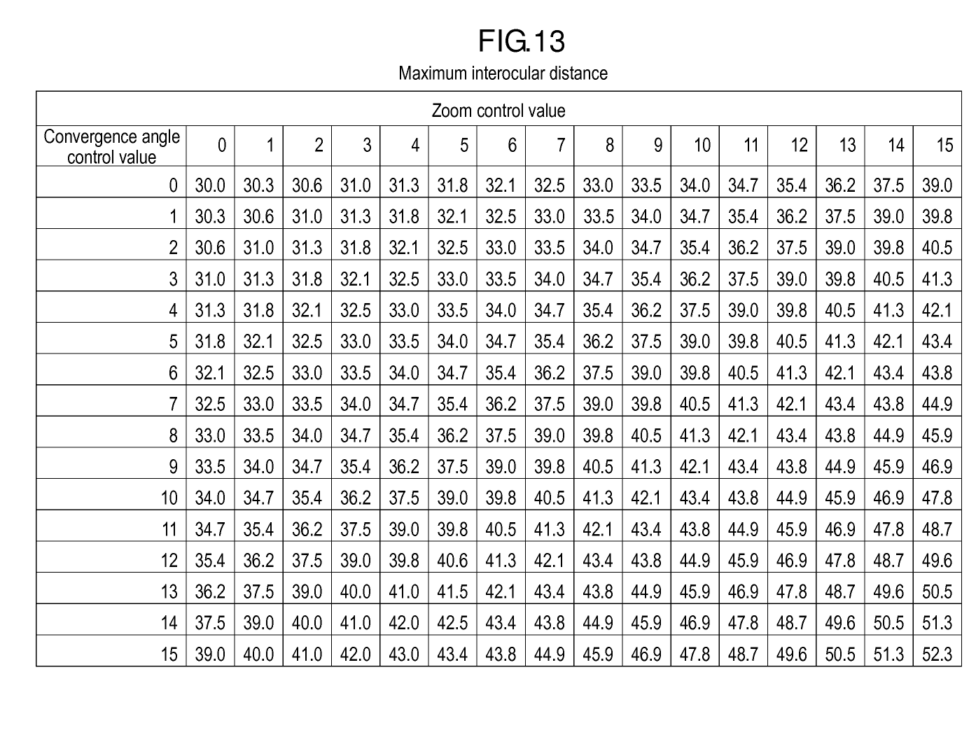

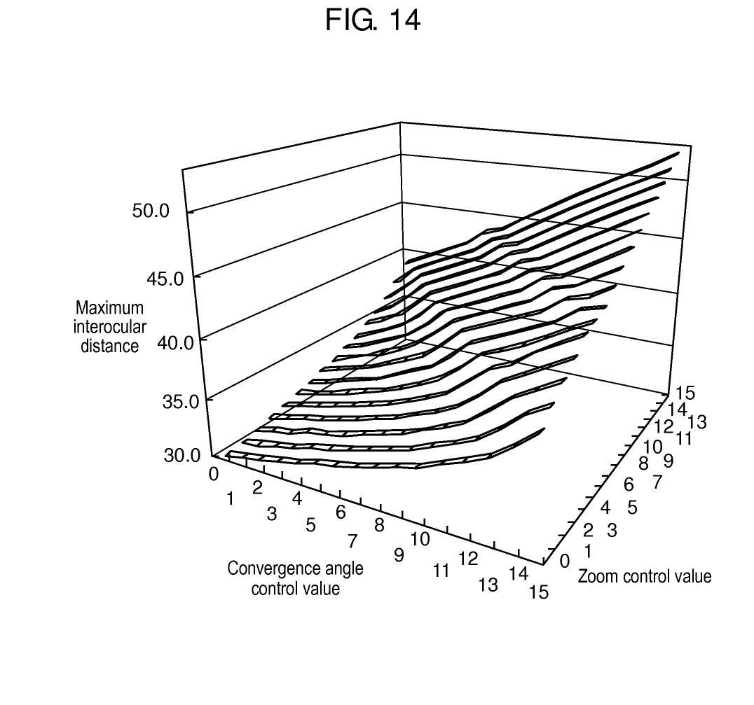

Thus, stereo camera 200 according to this exemplary embodiment stores information shown in FIGS. 13 and 14 as a control information table. The control information table stored in storage unit 180 by stereo camera 200 will be described with reference to FIGS. 13 and 14. FIG. 13 is a table showing the control information table as a table. FIG. 14 is a graph plotting the control information table shown in FIG. 13 on coordinates.

As shown in FIGS. 13 and 14, stereo camera 200 defines sixteen-stage convergence angles as the convergence angle formed by left-eye camera 210 and right-eye camera 220. Here, a convergence angle control value indicates a stage of the convergence angle. When the convergence angle control value is zero, the convergence angle formed by left-eye camera 210 and right-eye camera 220 becomes zero. On the other hand, when the convergence angle control value is fifteen, the convergence angle formed by left-eye camera 210 and right-eye camera 220 becomes largest. That is, as the convergence angle control value is decreased, the convergence angle decreases. On the other hand, as the convergence angle control value is increased, the convergence angle increases.

As shown in FIG. 14, in stereo camera 200, the maximum interocular distance increases as the convergence angle formed by left-eye camera 210 and right-eye camera 220 increases. Also, as the zoom ratio of left-eye camera 210 and right-eye camera 220 increases, the maximum interocular distance increases.

Controller 150 in stereo camera 200 determines, by referring to the control information table stored in storage unit 180, how far the optical axis of left-eye camera 210 and the optical axis of right-eye camera 220 can be separated from each other for each relationship between the zoom ratio of left-eye camera 210 and right-eye camera 220 and the convergence angle formed by left-eye camera 210 and right-eye camera 220. Controller 150 in stereo camera 200 also determines, by referring to the control information table stored in storage unit 180, in what range the zoom ratio of left-eye camera 210 and right-eye camera 220 can be changed for each relationship between the convergence angle formed by left-eye camera 210 and right-eye camera 220 and the distance between the optical axis of left-eye camera 210 and the optical axis of right-eye camera 220.

[2-3. Operation]

An operation in stereo camera 200 will be described with reference to FIGS. 6 to 8.

FIG. 6 is a flowchart showing an operation in a standby state of stereo camera 100 according to the first exemplary embodiment. FIG. 7 is a flowchart showing an operation in stereo camera 100 according to the first exemplary embodiment when at least one of left-eye camera 110 and right-eye camera 120 is moved horizontally. FIG. 8 is a flowchart showing an operation in stereo camera 100 according to the first exemplary embodiment when an instruction to change the zoom ratio of left-eye camera 110 and right-eye camera 120 is received.

Unlike stereo camera 100 according to the first exemplary embodiment, stereo camera 200 in a standby state acquires information on a convergence angle formed by left-eye camera 210 and right-eye camera 220 after step S120 in FIG. 6. This allows stereo camera 200 to refer to information on the convergence angle formed by left-eye camera 210 and right-eye camera 220 when an instruction to move at least one of left-eye camera 210 and right-eye camera 220 horizontally or an instruction to change the zoom ratio of left-eye camera 210 and right-eye camera 220 is given from a user.

Also, unlike stereo camera 100 according to the first exemplary embodiment, stereo camera 200 refers to the control information table shown in FIGS. 13 and 14 in step 210 in FIG. 7 when receiving an instruction from a user to move at least one of left-eye camera 210 and right-eye camera 220 horizontally. Then, stereo camera 200 determines whether a target value of the distance after movement is in a movable range or not by referring to the control information table shown in FIGS. 13 and 14. That is, when receiving an instruction to move at least one of left-eye camera 210 and right-eye camera 220, stereo camera 200 considers the convergence angle formed by left-eye camera 210 and right-eye camera 220 to determine a movable range in which at least one of left-eye camera 210 and right-eye camera 220 can be moved.

Also, unlike stereo camera 100 according to the first exemplary embodiment, stereo camera 200 implements, in parallel, adjustment of the convergence angle formed by left-eye camera 210 and right-eye camera 220 and horizontal moving of at least one of left-eye camera 210 and right-eye camera 220 in step S260 in FIG. 7. Specifically, stereo camera 200 increases the distance between the optical axis of left-eye camera 210 and the optical axis of right-eye camera 220 while increasing the convergence angle formed by left-eye camera 210 and right-eye camera 220.

Also, unlike stereo camera 100 according to the first exemplary embodiment, stereo camera 200, when receiving an instruction from a user to change the zoom ratio of left-eye camera 210 and right-eye camera 220, refers to the control information table shown in FIGS. 13 and 14 in step S310 in FIG. 8.

Also, unlike stereo camera 100 according to the first exemplary embodiment, in step S360 in FIG. 8, stereo camera 200 implements, in parallel, adjustment of the convergence angle formed by left-eye camera 210 and right-eye camera 220 and change of the zoom ratio of left-eye camera 210 and right-eye camera 220. Specifically, stereo camera 200 changes the zoom ratio of left-eye camera 210 and right-eye camera 220 to a wider angle while increasing the convergence angle formed by left-eye camera 210 and right-eye camera 220.

[2-4. Effects and Others]

Thus, stereo camera 200 according to this exemplary embodiment has the structure including controller 150 and interocular distance drive unit 170. The structure including controller 150 and interocular distance drive unit 170 can adjust the convergence angle formed by left-eye camera 210 and right-eye camera 220. When the zoom ratio of left-eye camera 210 and right-eye camera 220 is the same, the structure including controller 150 and interocular distance drive unit 170 can move at least one of left-eye camera 210 and right-eye camera 220 horizontally in a wider range when the convergence angle is a first angle than when the convergence angle is a second angle that is smaller than the first angle.

This allows stereo camera 200 to move the distance between the optical axis of left-eye camera 210 and the optical axis of right-eye camera 220 in as wide a range as possible, considering the convergence angle formed by the two cameras.

### Other Exemplary Embodiments

As described above, the first and second exemplary embodiments have been described as illustrations of techniques disclosed in the present application. However, the techniques in this disclosure are not limited to these, and are applicable to embodiments in which appropriate modification, replacement, addition, omission, or the like has been made. Also, the components described in the above-described first and second exemplary embodiments may be combined to form new embodiments.

Thus, other exemplary embodiments will be illustrated below.

In the first and second exemplary embodiments, in step S250 shown in FIG. 7, when an instruction for movement beyond a movable range of the two cameras is received, the process shifts to step S260. However, this configuration is not necessarily limiting. For example, in step S250, even when an instruction for movement beyond a movable range of the two cameras is received, operations of the two cameras may be left stopped.

In the first and second exemplary embodiments, in step S350 shown in FIG. 8, when an instruction to change the zoom ratio beyond a range in which the zoom ratio of the two cameras can be changed is received, the process shifts to step S360. However, this configuration is not necessarily limiting. For example, in step S350, even when an instruction to change the zoom ratio beyond a range in which the zoom ratio of the two cameras can be changed is received, change of the zoom ratio of the two cameras may be left stopped.

In the first and second exemplary embodiments, the horizontal width of beam splitter 130 and beam splitter 230 is constant. However, this configuration is not necessarily limiting. For example, stereo camera 100 and stereo camera 200 may be configured to be able to change beam splitter 130 and beam splitter 230 for different beam splitters with different widths. In this case, the control information table stored in storage unit 180 may be updated to change an upper limit to which the distance between the optical axes of the two cameras can be increased in accordance with the horizontal width of a beam splitter after the change. This allows stereo camera 100 and stereo camera 200 to change the distance between the optical axes of the two cameras appropriately for each beam splitter fitted.

In the first and second exemplary embodiments, the control information table includes the maximum interocular distance. However, this configuration is not necessarily limiting. For example, the control information table may include information showing positions of the carriages on which the two cameras are placed in place of the maximum interocular distance. In short, the control information table only needs to include information to calculate the distance between the optical axes of the two cameras.

As above, the exemplary embodiments have been described as illustrations of techniques in this disclosure. For this, the accompanying drawings and the detailed description have been presented.

Accordingly, components included in the accompanying drawings and the detailed description may include not only components essential to solve problems but also components that are not essential to solve problems, in order to illustrate the above techniques. Therefore, those unessential components should not be recognized to be essential directly from the fact that those unessential components are included in the accompanying drawings and the detailed description.

Also, the above-described exemplary embodiments are intended to illustrate the techniques in this disclosure, and thus various kinds of modification, replacement, addition, and omission can be made within the scope of the claims or the scope of the equivalents.

What is claimed is:

1. A stereo camera comprising:
a first camera for capturing an image of a subject, the first camera having a zoom function of adjusting a zoom ratio;
a second camera for capturing an image of a subject, the second camera having the zoom function;
an optical component disposed on an optical path when the first camera images a subject, and on an optical path when the second camera images a subject; and
an adjuster for adjusting a distance between an optical axis of the first camera and an optical axis of the second camera by moving at least one of the first camera and the second camera horizontally, the adjuster being able to move at least one of the first camera and the second camera horizontally in a wider range when the zoom ratio of the first camera and the second camera is a first ratio than when the zoom ratio is a second ratio that is lower than the first ratio.

2. The stereo camera according to claim 1, further comprising:
a receiver for receiving an instruction from a user on the distance between the optical axis of the first camera and the optical axis of the second camera; and
a controller for controlling the first camera and the second camera to increase the zoom ratio of the first camera and the second camera when the adjuster receives an instruction from the user to move at least one of the first camera and the second camera horizontally beyond a range in which at least one of the first camera and the second camera is moved horizontally.

3. The stereo camera according to claim 1, wherein the adjuster adjusts a convergence angle formed by the first camera and the second camera; and when the zoom ratio of the first camera and the second camera is the same, the adjuster moves at least one of the first camera and the second camera horizontally in a wider range when the convergence angle is a first angle than when the convergence angle is a second angle that is smaller than the first angle.

4. A stereo camera comprising:
a first camera for capturing an image of a subject, the first camera having a zoom function of adjusting a zoom ratio;
a second camera for capturing an image of a subject, the second camera having the zoom function;
an adjuster for adjusting a distance between an optical axis of the first camera and an optical axis of the second camera by moving at least one of the first camera and the second camera horizontally;
an optical component disposed on an optical path when the first camera images a subject, and on an optical path when the second camera images a subject; and
a controller being able to change the zoom ratio of the first camera and the second camera in a wider range when the distance between the optical axis of the first camera and the optical axis of the second camera is a first distance than when the distance is a second distance that is larger than the first distance.

5. The stereo camera according to claim 4, further comprising:
a receiver for receiving an instruction from a user on the zoom ratio of the first camera and the second camera;
wherein when the controller receives an instruction to change the zoom ratio of the first camera and the second camera to a wider angle beyond a range in which the zoom ratio of the first camera and the second camera is changed, the adjuster moves at least one of the first camera and the second camera horizontally to shorten the distance between the optical axis of the first camera and the optical axis of the second camera.

6. The stereo camera according to claim 4, wherein the adjuster adjusts a convergence angle formed by the first camera and the second camera; and when the distance between the optical axis of the first camera and the optical axis of the second camera is the same, the adjuster moves at least one of the first camera and the second camera horizontally in a wider range when the convergence angle is a first angle than when the convergence angle is a second angle that is smaller than the first angle.
